(19) United States
(12) Patent Application Publication
(10) Pub. No.: US 2015/0135322 A1
(43) Pub. Date: May 14, 2015

(54) METHOD FOR SAFEGUARDING WINDOWS OPERATING SYSTEM AGAINST COMPUTER VIRUSES, SPYWARE AND/OR HACKERS, AND HARD DISK USED IN SAID METHOD

(71) Applicants: Julio Enrique Rovelli, Bogota (CO); Cristina Viviana Rovelli, Bogota (CO)

(72) Inventors: Julio Enrique Rovelli, Bogota (CO); Cristina Viviana Rovelli, Bogota (CO)

(21) Appl. No.: 14/403,354

(22) PCT Filed: May 9, 2013
(86) PCT No.: PCT/IB2013/053731

§ 371 Date: Nov. 24, 2014

(30) Foreign Application Priority Data
May 29, 2012 (AR) P20120101887

(51) Int. Cl. G06F 21/56; G06F 12/14

(52) U.S. Cl. CPC G06F 21/561; G06F 12/14
USPC 726/24; 711/103

(57) ABSTRACT

The invention relates to a method for safeguarding a Windows operating system against computer viruses, spyware, and/or hackers and to the hard drive used in the method. The method includes the following steps: any version of Windows, the programs and corresponding files associated with the operating system and the drivers associated with the equipment are installed in a first partition of the hard drive. The files of all of the utility associated to the programs contained and installed in the first partition are redirected to a second partition. The information contained in the first partition is copied to a third backup partition in a USB flash memory integrated in a logic board belonging to the hard drive containing it. The hard disk includes a logic board and storage plates. First and second partitions are included in the storage plates. The first partition containing the Windows Operating System with its associated drivers plus the programs installed. The second partition containing all of the files redirected from the first partition. In addition, a third backup partition is included, defined by a USB flash memory disposed integrally in the logic board in the hard drive.

### CROSS REFERENCE TO RELATED APPLICATION

This application is a national stage entry of PCT/IB2013/053731filed May 09, 2013, under the International Convention claiming priority over Argentinean Application No. P20120101887 filed May 29, 2012.

### TECHNICAL FIELD OF THE INVENTION

The present invention relates to a method for safeguarding a Windows operating system against computer viruses, spyware, and/or hackers and the hard drive used in this procedure, in addition to AR 052958 B1, for any damage and also contributes to the protection of user-generated files. This does not preclude the user to protect theft files under standard procedures, installed the following utilities: antivirus, antispam, firewall, spyware, etc. and periodically performing a backup of the documents.

### STATE OF THE ART AND INNOVATIVE SOLUTION

In general, and as it is known, that conventional protection systems do not guarantee a truly effective guard or in some cases are inefficient, since in practice they have proven situations of advanced damage, which they fail, or the time required to repair the problem is excessive.

The damage that is currently caused in the Windows operating system and its associated software, by the computer viruses, spyware, hackers, etc. means, in average terms, not less than 2 working hours for the optimal recovery of the systems. This, without mentioning the possibility of considering some drivers as irrecoverable, since in many cases, users do not have the original copies.

In addition, in the existing recovery programs, in most of the cases, they are not effective or are inefficient, in case of severe damage, because they do not achieve the optimal restoration of the systems; deriving in the need to reinstall the Windows as well as the programs and associated drivers, or the commitment to the repair time is excessive in terms of user's productivity.

In the AR 052958 B1 patent, which belongs to the same inventors, discloses a procedure for safeguarding the Windows operating system against computer viruses, spyware and/or hackers and a hard drive used in this procedure ensuring a 99.9% success rate in the recovery of the original performance of the Windows installed and all the utility and associated drivers, reporting a high performance in the operational agility systems.

Basically, it is detailed in the AR 052958 B1, the characteristic of files redirection where the partition 3 is the one that contains the backup of the partition 1, wherein there are three partitions:
partition 1, which contains the Windows operating system (any version). The programs and utilities installed (for example: Office, Adobe Reader, Corel Draw, Games, etc).

The files corresponding to these utilities redirected to Partition 2.

It is very important to remember that the user is absolutely responsible of redirecting all of his files to this partition, since in case of having to copy the content from partition 3 to partition 1, if there were files contained (before this operation) in partition 1, the user would lose this files. Another option would be to contact software providers, so that they contemplate the possibility of, during the process of installation of their programs, to suggest user to redirect his files to partition 2.
b) Partition 2, which contains all the files of the PC processed with the utilities installed on the partition 1.
c) Once this procedure is finished, a backup copy of partition 1 to partition 3 is made.

The inventors improved this procedure and now provides a new realization variant with also the provision of another backup procedure of the Windows operating system against computer viruses, spyware, and/or hackers and hard drive used in this procedure, where is protected against writing and also against reading and writing of the partition 3.

This variant includes making only two partitions to the hard drive, hereinafter called “partition 1” and “partition 2”. So, what happens with the partition 3?

This variant of making two partitions to the hard drive is imposed due to the current state of the art since at this time, the performance and speed of the USB devices is much higher with respect to the filing date of the original patent application belonging to the same inventors AR 052958B1 (2006), at which the standard USB was in many cases 1.0 and in rare cases 1.1, being the yield much lower with respect to the current state of the art (at present the standard is USB 3.0).

Thus, the modification to the AR 052958B1 patent, is that until now, has not been mentioned a third partition on the hard drive, now partition 3 will be mentioned, which will not be physically contained in the plates of the hard drive (but may be included, for example, in the logic board of the hard drive, said “partition 3” will be located on a USB memory device or similar (at least 2.0 or preferably of greater performance or speed, in the current state of the art the standard is USB 3.0).

Remember that partition 3, in this proposed modification, is not physically in the plates of the hard drive but on a USB memory or similar (is of utmost importance that the hard drive manufacturers integrate into the logic board of the hard drive this USB memory or another similar memory), will copy the information contained in partition 1 in which we have called partition 3 (which is located on the USB device previously mentioned, built into the logic board of the hard drive).

There are many ways of placing the USB device, that can also be protected against “writing” or against “reading-writing”, the ways to perform these protections will be described later. Remember that in the patent AR 052958 B1, it was mentioned the concept of “protected partition” (PP). Variant which is incorporated includes locating the partition 3 built into the logic board of the hard drive, because the partition 3 would be contained on the USB device arranged for this purpose, being apart, the USB memory of the logic board of the hard drive, would be a constituent part of the disk.

An additional variant of this option would be to integrate the USB memory, also in the Main Board, as a constituent part thereof, being able also to offer this possibility to the Main Boards manufacturers around the world.

Therefore, in what way can it protect against writing a USB memory? Two procedures are mentioned:
1) protection against reading-writing
2) protection against writing only

### Protection Against Reading-Writing

It is considered a simple flash drive (this procedure is described with a 16 gb USB flash drive), and at the same time it is connected this flash drive to a USB port 2.0 that is free inside the Main Board (it is important that it is 2.0 not 1.0 or 1.1, as this dramatically affects the speed of the restoration process of the system).

This flash drive would become the partition 3 (described in the patent AR 052958 B1), which makes the copy of the partition 1.

The layout of the external connector of the USB flash drive is as follows:

| PIN | Name | Description |
|---|---|---|
| 1 | VCC | 5 Volts continuous current (+5 VDC) |
| 2 | D− | Negative Data (Data−) |
| 3 | D+ | Positive data (Data+) |
| 4 | GND | Mass (Ground) |

The way to protect the partition 3 against reading-writing, simply includes interrupting the electricity to the flash memory, meaning placing a simple switch that blocks the signal named “VCC” (see FIG. 1)

### Writing Protection Only

The way to protect only against writing (and not reading) of the USB memory is as follows:

It is mentioned as an example the internal integrated circuit (flash memory) of a typical USB flash drive (as there are plenty of available models), is treated as illustrative example model:

HY27UH08AG5B Series 16 Gbit (2 G×8 bit) NAND Flash, (which corresponds to an internal memory of a 16 gb flash drive (storage capacity of 16 Giga Bytes) (see FIG. 2).

The way to protect against writing the flash drive is to place a switch to enable or disable the signal called “wp” (“write protect”, “protection against writing”).

With the “wp” (“write protect”, “protection against writing”) connected, the switch connects the output “wp” to the control circuit of the USB flash memory.

With the signal “wp” (“write protect”, “protection against writing”) disconnected, the switch disconnects the output “wp” (“write protect”, “protection against writing”) to ground. (see FIG. 3).

To facilitate the use of the system, it would be desirable to locate the switch on the outside of the equipment (so to be easily accessible to the user), along with a LED indicator (quick view) that points out the protection against writing on the partition 3, preferably placed in the front of the computer case. This alternative of the present invention would be possible to offer to computer case manufacturers, because it could have cases with at least one LED indicator on its front, which light up when the USB memory integrated in the logic board of the hard drive enables the writing.

It would be under the entire responsibility of the user to unprotect against writing the partition 3, since the above-mentioned light indication will inform if the protection is on or off.
3) OBJECTIVES
   The objectives are:

Protection of the Windows Operation System (in any of its current versions).

Protection of the programs associated with the operating system.

Protection of the various associated Drivers devices.

As well, one secondary application (though not infallible) results in the protection of the associated files, avoiding the user from making a backup copy “unscheduled”, when the computer damage occurs.

In this regard, is again clarified, this last aspect is considered an additional contribution to the system, which does not preclude the protection of information through the traditionally known systems (installation of anti-virus, backup copies of the files processed by the user, etc.)
4) ADVANTAGES:

Efficiency in the systems re-operation: under the proposed working alternative, the affected system can be recovered in a matter of minutes (depending on the number of programs installed on the computer) if the data contained in the partition 2 is not damaged.

Saving money: reduction of variable costs for the user, since in the first instance the restoration operation is very simple to run, unless the damage caused has progressed to the information contained in partition 2, in which case, it is recommended to call the technician.

Restoration operation suitable for unskilled computer users: the ease of the restoration procedure makes it accessible to any user, not necessarily requiring advanced knowledge in the field.

### DESCRIPTION OF THE FIGURES

FIG. 1, shows a diagram of a typical flash drive with a switch on the power supply line (VCC).

FIG. 2, shows a typical 16 Gb flash memory.

FIG. 3, shows a switch that connects or disconnects the signal WP.

FIG. 4, illustrates some of the constituent parts of a hard drive, highlighting for example, the plates (where the reading and writing operation of the information is performed), heads which carry out such operation, and the logic board which commands (among many others) above mentioned heads. The hardware modification proposed to the hard drives manufacturers, is to add to the logic board referenced with the number 1 and the USB memory (or flash drive or similar), described with the number 2.

FIG. 5, illustrates the flash drive (2) built into the logic board of the hard drive (1).

FIG. 6, illustrates as an example, the main board MSI model H61MU-E35, taking an expanded sector of the Main Board, which is sector 3 (it corresponds to the input/output USB of such Main Board). Also connecting the USB connector (which would be integrated into the logic board of the disc) to the USB input/output on the Main Board.

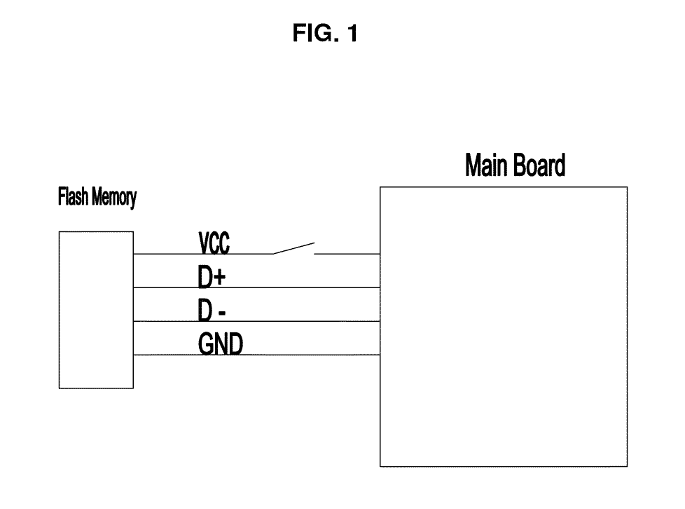

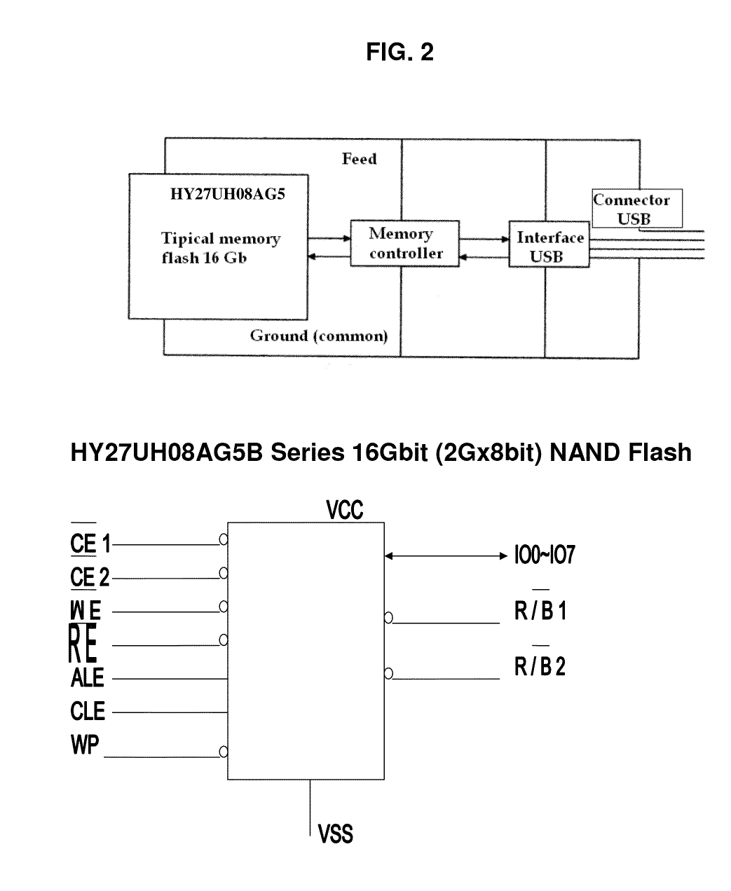

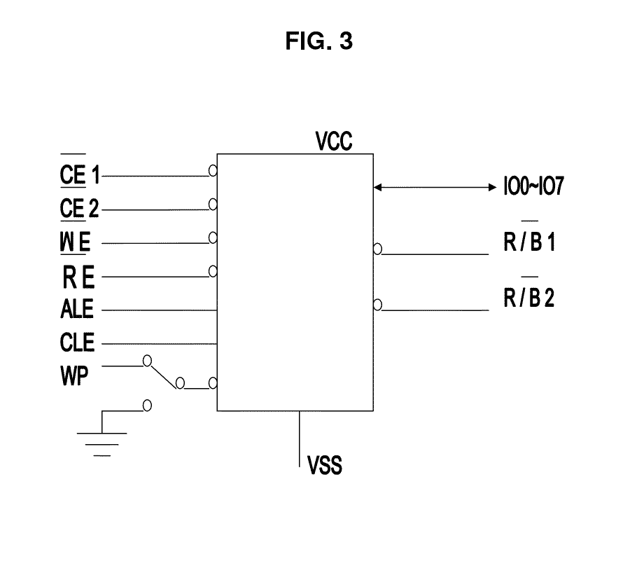

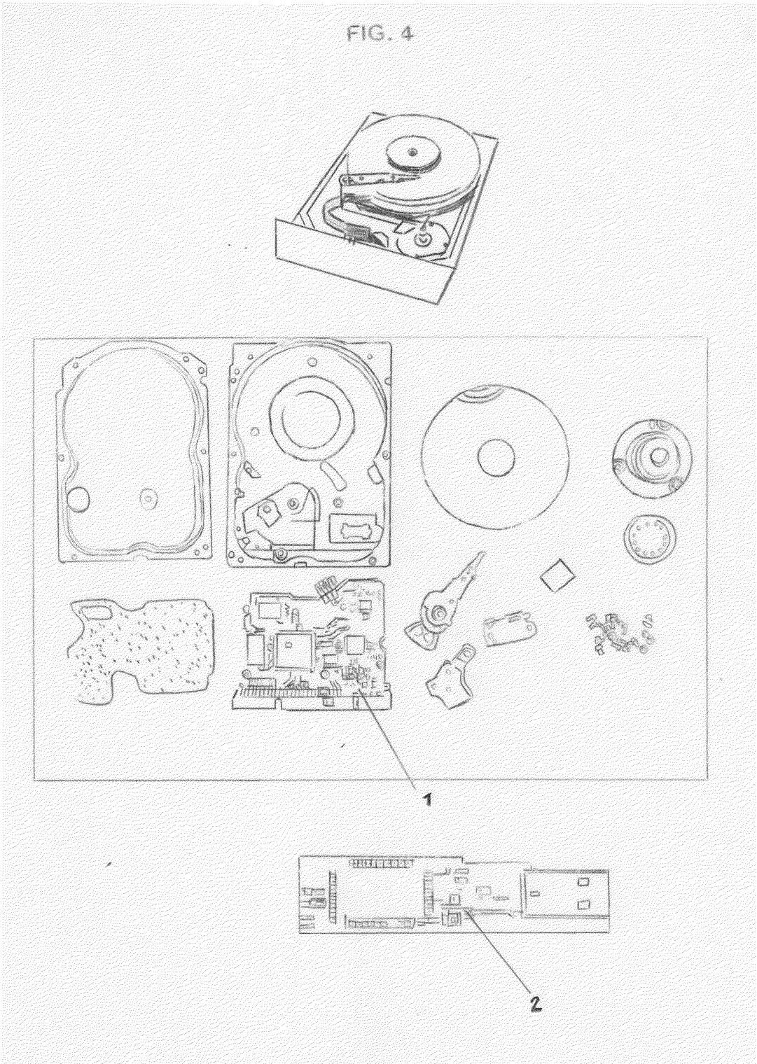

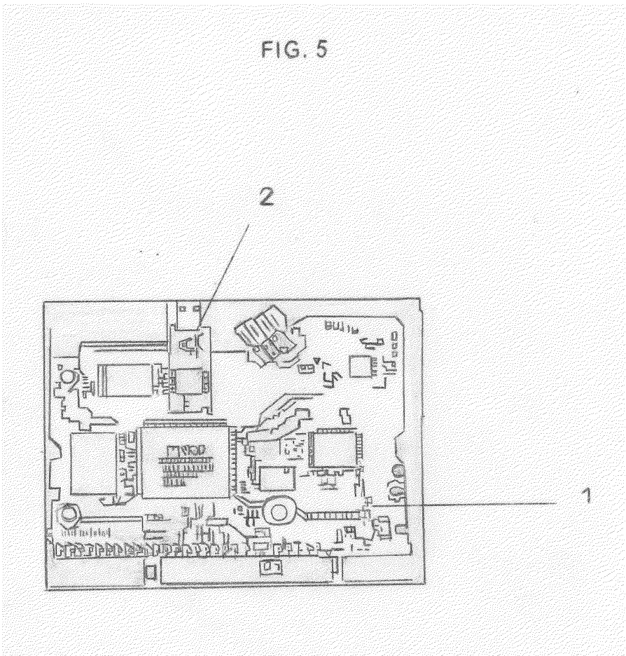

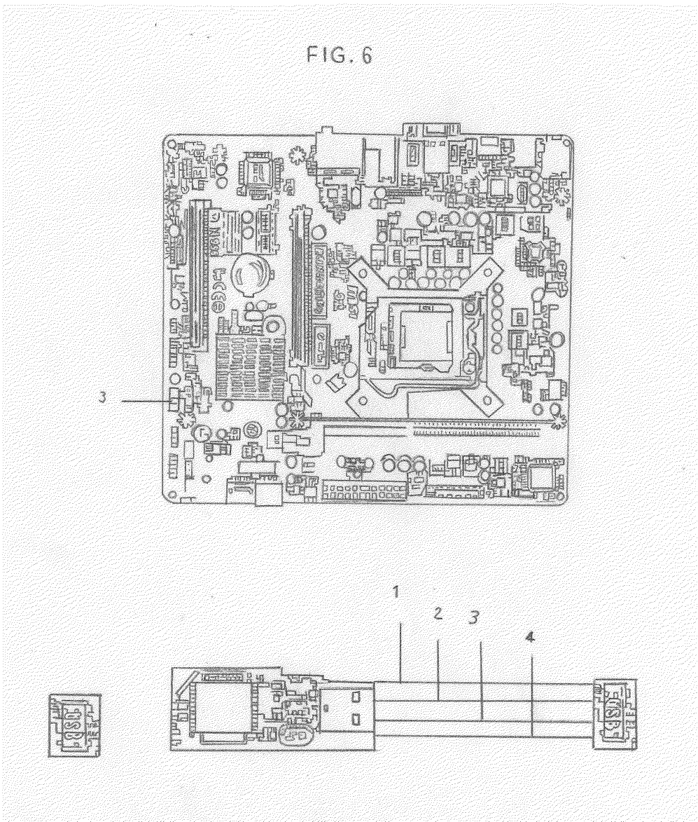

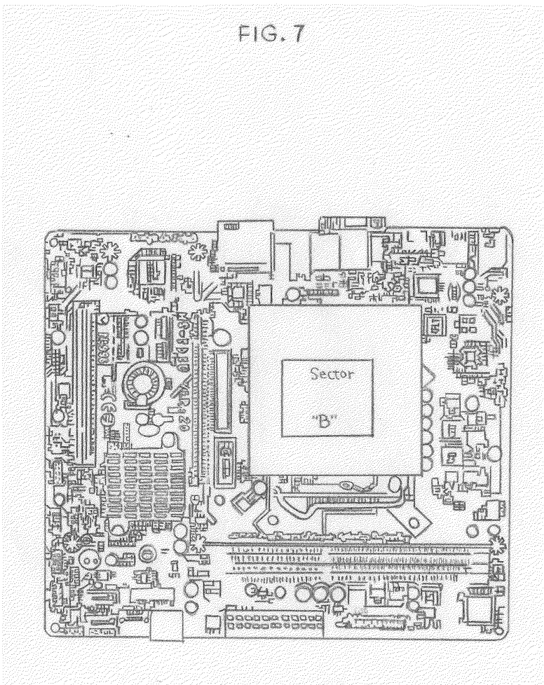

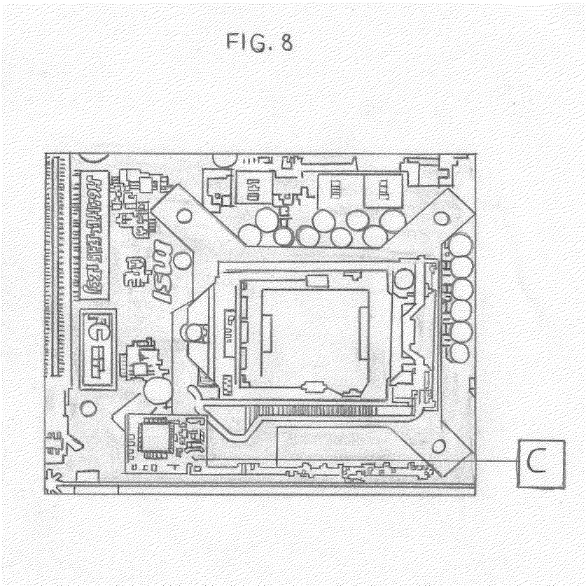

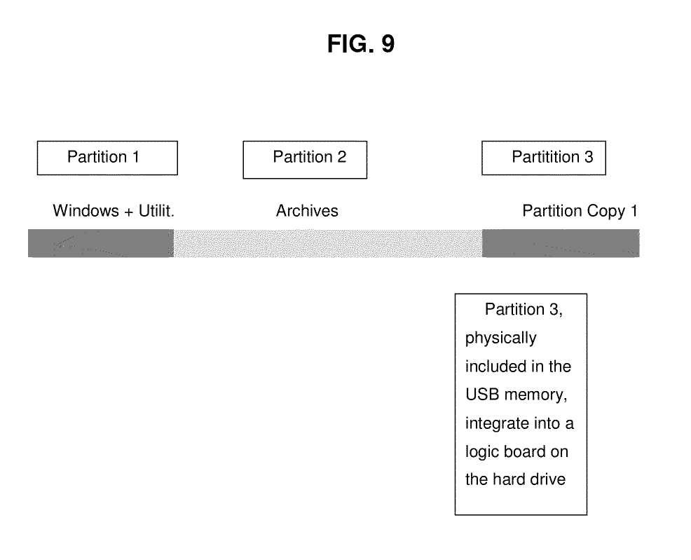

In FIGS. 2 and 3, show the following references of each connector of the flash memory:

IO7-IO0 data input/output

CLE authorizing the secure command (CLE)

ALE authorizing the data locking (Address Latch Enable)

CE1, CE2 authorizing the chip (Chip Enable)

RE authorizing the reading (Read Enable)

WE authorizing writing (Write Enable)

WP writing protection (Write Protect)

R/B1, R/B2 ready/busy (Ready/Busy)

VCC Power supply (Power Supply)

VSS Mass (Ground)

NC No connected (No Connection)

The flash drive (built into the logic board of the hard drive) is connected to the USB input/output of the Main Board, using four conductive wires, which constitute the following signals:
1: +5 Volts CC (VCC)
2: Positive Data Signal (+D)
3: Negative Data Signal (−D)
4: Ground (Gnd)

This description of each connection line of the flash drive is placed merely for illustrative purposes, whereby the order of the connectors is not necessarily respected.

FIG. 7, shows another modification of the hardware (Main Board) but this time directed to the motherboard manufacturers, which is to integrate the flash drive directly to the motherboards (Main Board). See illustration attached, in this illustration, the sector “B” is magnified.

FIG. 8, shows the omission of the flash drive USB connector, since such device is directly integrated in the Main Board, see indicated as (C).

FIG. 9, shows schematically the procedure of the present invention.

In summary, the method comprises the steps of:
a) Installing Windows in any of its versions, the programs with the associated files to that operating system, and drivers linked to the equipment in a first partition on the hard drive.
b) Redirecting to a second partition, all files associated with the programs contained and installed on the first partition.
c) Copying to a third backup partition the information contained in the first partition on a USB flash memory integrated into a logic board of the hard drive that contains it.

1-2. (canceled)

3. A method for safeguarding a windows operating system against computer virus, spyware, or hackers comprising the steps of:
built in a USB flash memory into a logic board of a hard drive of a computer;
finishing assembling the computer by using a standard method;
installing on the computer a first partition, the first partition located on storage plates of the hard drive, the first partition including a windows operation system, associated programs with the windows operating system, and drivers linked to the computer;
redirecting to a second partition all files associated with the programs contained and installed on the first partition,
copying to a third backup partition the information contained in the first partition, wherein the third back up partition is built in an USB flash memory; and
wherein the third partition is not physically located on the hard drive; but in the USB flash memory that is integrated on the logic board of the hard drive or in the main board.

4. The method according to claim 3, wherein the USB flash memory is connected to a free USB port located inside the Main Board

5. The method according to claim 3, further including the step of installing at least one of two switches.
the first switch enables o disables power supply to the USB flash memory that is built into the logic board of the hard disk,
the second switch protects against writing or reading writing the USB flash memory integrated on the logic board of the hard drive.

6. The method according to claim 5, wherein the switch is located on an external wall of the computer.

7. The method according to claim 3, wherein the USB flash memory is built in into the main board.

8. A hard drive comprising:
a USB flash memory built into a logic board of the hard drive;
a first partition, the first partition located on storage plates of the hard drive, the first partition including a windows operation system, programs associated with the windows operating system, and drivers linked to the computer;
a second partition, the second partition to which all files associated with the programs contained and installed on the first partition are redirectioned
a third partition, the third is a backup partition and contains the information of the first partition, and is located in the USB flash memory that is built in the logic board of the hard drive or in the main board.

9. The hard disk according to claim 8, further including at least one of
the first switch enables or disables power supply to the USB flash memory that is built into the logic board of the hard disk,
the second switch protects against writing or reading writing the USB flash memory integrated on the logic board of the hard drive.
